(19) United States
(12) Patent Application Publication
(10) Pub. No.: US 2004/0107104 A1
(43) Pub. Date: Jun. 3, 2004

(54) Method and apparatus for automated identification of animal sounds

(76) Inventor: Richard A. Schaphorst, Jenkintown, PA (US)

Correspondence Address: WILLIAM H. EILBERG, ESQ., THREE BALA PLAZA, SUITE 501 WEST, BALA CYNWYD, PA, 19004, US

(21) Appl. No.: 10/308,387

(22) Filed: Dec. 3, 2002

(51) Int. Cl. G10L 21/00

(52) U.S. Cl. 704/270

(57) ABSTRACT

A hand-held unit automatically identifies an animal sound, such as a bird call, by comparing an incoming sound with a stored database. The incoming sounds are divided into phrases, and each phrase is characterized by a finite set of parameters. These parameters are used to identify the nature of each phrase, and the animal is identified by searching a database for characteristic patterns of phrases. In another embodiment, a number of such units are located across a wide area, all of the units being connected to a central computer. The computer analyzes the information received from the various units, so as to track the migratory patterns of birds or other animals.

### BACKGROUND OF THE INVENTION

This invention relates to the field of identification of animal sounds, especially bird calls. The invention provides an apparatus and method for automatically identifying bird songs, or other animal sounds. In another embodiment, the invention provides an apparatus and method for tracking migratory patterns of birds or other animals.

Bird watchers seek to identify positively the species of birds observed on an outing. In many cases, birds can be identified visually, either with the naked eye or with binoculars. But in many other cases, visual identification is difficult or impossible, perhaps because the bird watcher is in a forest, where the birds are camouflaged by trees, or because the bird watcher is too far from the bird to identify it positively. In such cases, knowledge of the calls produced by particular species helps to identify the birds making each sound. Even in cases where the bird can be visually identified, sound identification can be used to confirm what is determined by visual observation.

In one of its aspects, the present invention provides an automated, portable device that can automatically identify birds, or other animals, based on the songs or calls they make. This device is especially useful for bird watchers in the field.

U.S. Pat. No. 5,056,145 describes a digital sound data storing device, which can be used to identify bird calls. However, the cited patent provides no explicit teaching of the procedure used for such identification, and it is believed that the patented invention requires that a human operator listen to various bird calls, and to compare them, qualitatively, to bird calls stored in the system.

Other signal processing systems, not intended for use in identifying the sounds of birds or other animals, are known from the prior art, but such systems rely on point-by-point analysis of complex waveforms. Simply comparing two waveforms, such as by using a least squares fit, or some other technique of numerical analysis, is not believed reliable in identifying bird calls. One reason is that, even within a given species, the call of each bird may be quite different. Different birds, even within the same species, may emit calls having slightly different frequencies and different timing patterns. A simple comparison of two waveforms is therefore not the optimum method of identifying birds. Moreover, direct comparison of complex waveforms requires a substantial amount of computation, increasing the time required to obtain a result.

The present invention provides a method and apparatus which identifies bird calls, or other sounds emitted by animals, based on relatively macroscopic parameters of such sounds. The invention therefore provides an efficient procedure which avoids the need for unduly complex numerical analysis. In another embodiment, the apparatus and method of the present invention can also be used to track migratory patterns of birds or other animals.

### SUMMARY OF THE INVENTION

In one embodiment, the invention comprises a hand-held, battery-powered unit, suitable for use by a bird watcher in the field. The unit includes a microphone for receiving sounds. A comb filter circuit separates the received sounds into narrow frequency bands. The sounds are parsed for phrases, i.e. continuous segments of sound, and each phrase is defined by a finite set of parameters. Examples of such parameters are the time from beginning to end (or the starting time and ending time), the highest frequency reached, the lowest frequency reached, etc. The sets of parameters are compared with a database of parameters associated with known phrases. Such comparison yields an identification of the phrases. The result is a pattern, or set of patterns, of phrases.

The patterns of phrases are then compared with a database of patterns. In general, an animal call can be categorized and stored as a pattern of phrases. Comparison of such patterns can determine the identity of the bird or other animal making a particular sound.

All of the above functions are preferably performed by one or more programmed microprocessors contained within the hand-held unit.

In another embodiment, a plurality of units, similar in concept to the hand-held unit described above, are positioned in various locations over a wide area. Each unit is connected, either by wire or by wireless connection, to a central computer which receives information from each of the units. From a knowledge of what animal call is received by what unit, and when, the central computer can infer information concerning the migratory patterns of such animals. The invention can therefore be used to track the migration of birds, whales, porpoises, or other animals.

The present invention therefore has the primary object of providing a method of identifying bird calls or other animal sounds.

The invention has the further object of providing a hand-held device which can be used by bird watchers, and others, to identify birds observed in the field.

The invention has the further object of providing an automated method and apparatus for tracking migratory patterns of birds and other animals.

The invention has the further object of providing a method of identifying animal calls, wherein the method does not require complex and extensive numerical comparison of waveforms.

The invention has the further object of providing a method of identifying bird calls, or other animal calls, by measurement and identification of a finite set of parameters associated with such calls.

The reader skilled in the art will recognize other objects and advantages of the present invention, from a reading of the following brief description of the drawings, the detailed description of the invention, and the appended claims.

### BRIEF DESCRIPTION OF THE DRAWINGS

FIG. 1 provides a block diagram of the major elements of the apparatus of the present invention.

FIG. 2 provides a block diagram showing the essential features of the identification procedure used in the present invention.

FIGS. 3 and 4 provide spectrographs that represent hypothetical bird calls, showing frequency versus time, these figures illustrating the method used in the present invention to analyze and recognize various types of calls.

FIG. 5 provides a block diagram of another embodiment of the present invention, in which there are a plurality of recognition units, all linked to a central computer, and used for monitoring the migratory patterns of birds or other animals.

### DETAILED DESCRIPTION OF THE INVENTION

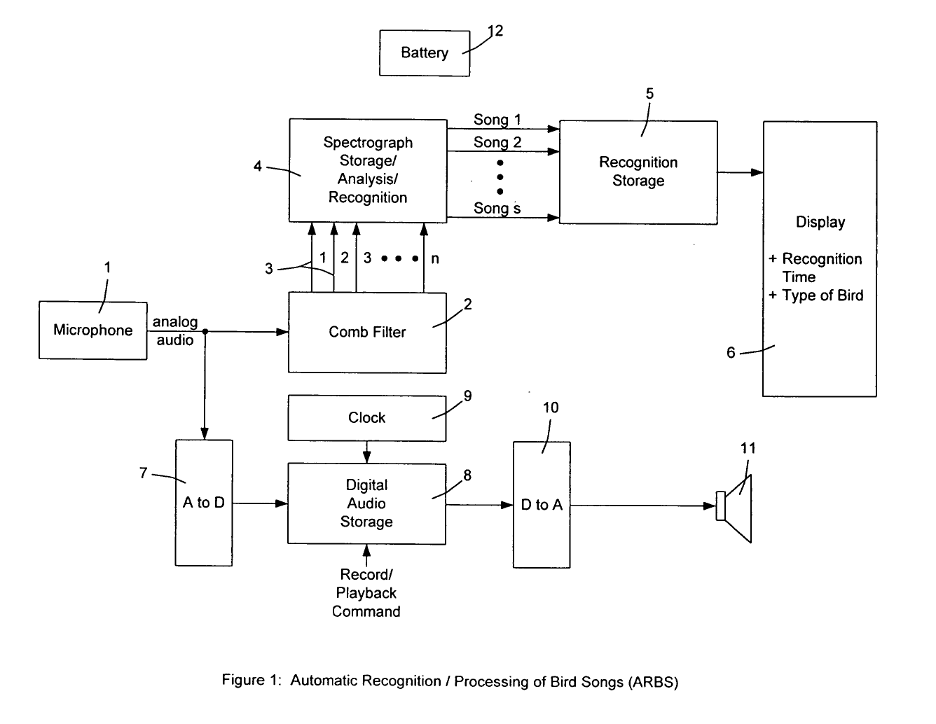

FIG. 1 provides a block diagram of the apparatus of the present invention, as configured for use by a bird watcher in the field. This apparatus is preferably a hand-held, battery-operated, portable device.

Microphone 1 provides an analog audio signal which is fed to comb filter 2. The comb filter continually measures the audio energy within multiple narrow frequency bands. In one example, if the overall bandwidth of the audio signal being processed is 10 kHz, there could be 128 frequency bins, in which each bin would have an average width of approximately 80 Hz. The multiple outputs of the comb filter, represented by arrows 3, are preferably sampled at approximately twice the bandwidth of a frequency channel (in the above example, at 160 Hz).

Each output of the comb filter comprises a number that represents the relative amplitude of the signal in the particular bin. This number can be digitized with a modest amount of precision, using as few as five bits to represent the relative amplitude. The outputs of the comb filter are fed to a memory/processor device 4, designated the Spectrograph Storage/Analysis/Recognition (SAR) unit. It is in the SAR unit that spectrographs of bird songs are synthesized, analyzed, and identified.

When a bird song is recognized, the bird type, and the time of recognition, are stored in the Recognition Storage unit 5. The operator may be audibly and/or visually advised of the recognition by output device 6. The output device may include a CRT display, or other display, and/or a speaker capable of generating an audible message.

The device also preferably includes means for digital storage and playback of the sounds received by the microphone. Thus, the analog signal from the microphone is fed to analog-to-digital converter 7, which is connected to digital audio storage device 8. An electronic clock 9 places markers on the stored signal, so that the operator can later determine exactly when each sound was received. A conventional record/playback control governs the operation of the digital audio storage device, as indicated. The stored signals can be played back by sending the digital signal to digital-to-analog converter 10 and speaker 11.

When one considers the possibility of receiving many overlapping bird calls, it becomes clear that it is necessary, in general, for the SAR unit to store sounds of up to about 10 seconds in duration. This would require about 10 megabits of memory in the SAR device. Virtually an unlimited number of recognitions may be stored in the Recognition Storage unit because very few bits are required to define the type of bird recognized and the time of recognition.

In one embodiment, the apparatus described above takes the form of a hand-held unit, capable of being easily carried by a bird watcher in the field. In this case, the unit is powered by battery 12.

It is an important feature of the present invention that it does not require excessively complex computations to identify birds or other animals. In particular, the present invention does not include direct comparison of a complex waveform with a stored waveform, such as by a least-squares analysis or other numerical analysis. Instead, each bird call to be recognized is represented as a sequence of one or more “phrases”, and each phrase is represented by a relatively small set of discrete parameters. As used in this specification, the term “phrase” means a continuous element of sound. In general, a bird call is built up of a sequence of one or more phrases.

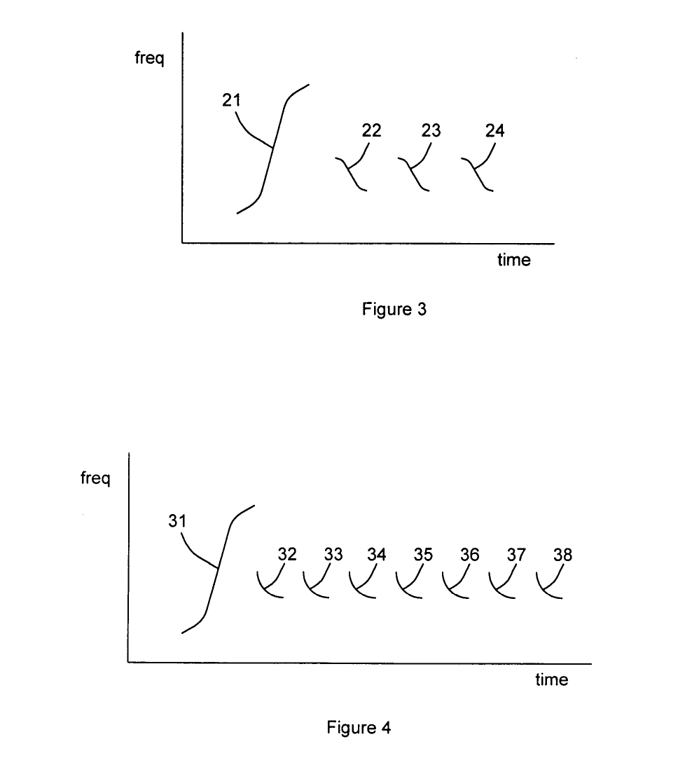

FIGS. 3 and 4 provide spectrographs, i.e. graphs of frequency versus time, showing the phrases that make up two hypothetical bird calls. For example, in the bird call represented in FIG. 3, there are four phrases, identified by reference numerals 21, 22, 23, and 24. The first phrase 21 is a continuous sound which starts at a low frequency and ends at a higher frequency. Phrases 22, 23, and 24 are substantially identical, and are shorter than the first phrase, and feature a slight decrease in frequency from beginning to end of the phrase. The position of each phrase relative to the horizontal (time) axis indicates the spacing between the phrases.

In another example, shown in FIG. 4, a hypothetical bird call includes a first phrase 31, followed by a pause, and then by a series of chirps 32-38, each chirp comprising a distinct phrase. Thus, the bird call represented in FIG. 4 comprises eight phrases.

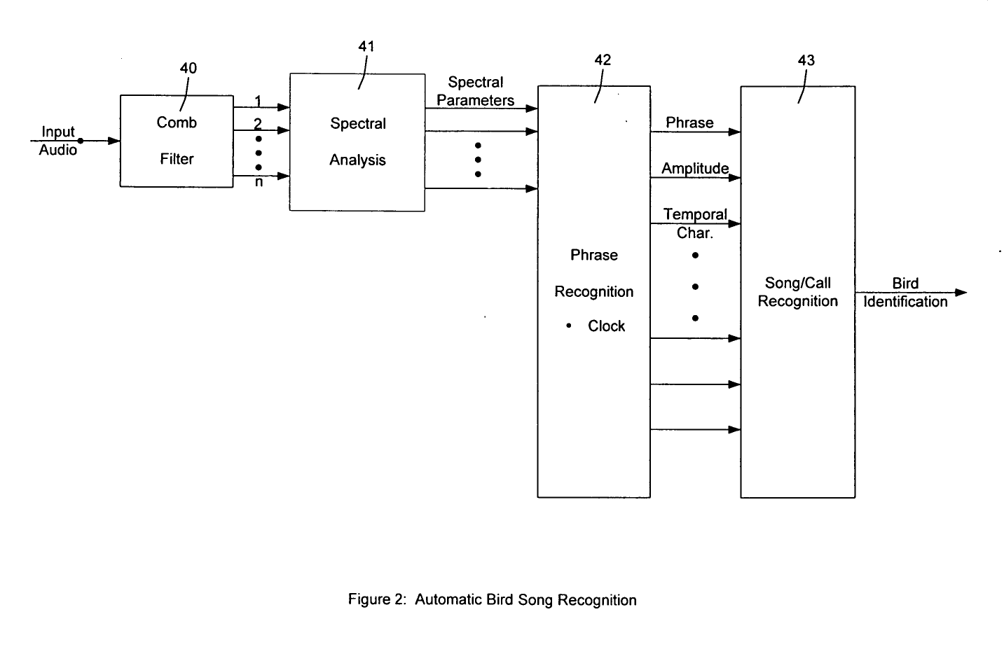

In the method of the present invention, the bird call, or other animal call, is recognized through identification of phrases, and by analysis of patterns of phrases. FIG. 2 shows more details of the apparatus which implements the analysis of phrases.

Following the comb filter 40 (which can be the same as the comb filter shown in FIG. 1), there is a spectral analysis unit 41, which takes the outputs of the comb filter and determines the spectral parameters of each phrase. Such parameters may include duration of the phrase (or the starting time and ending time of each phrase), the lowest frequency, the highest frequency, the average frequency, the median frequency, and the dominant frequency of the phrase. The parameters may also include the distribution of several dominant frequencies. The parameters may also include the percentage of silence between one phrase and the next.

Regardless of which parameters are used to characterize the phrases, all phrases, in the present invention, are represented by a finite set of such parameters. Clearly, the greater the number of parameters, the more accurate the representation. But in all cases, the number of parameters is finite, and may be relatively small, sometimes fewer than ten.

The information generated by spectral analysis unit 41 is fed to phrase recognition unit 42. The phrase recognition unit includes a memory in which there is stored information about a large number of possible phrases. Such stored information is also in the form of a set of parameters, of the same type as described above. The phrase recognition unit is programmed to compare a set of parameters received from the spectral analysis unit, and associated with a particular phrase, with sets of stored parameters representing different types of phrases. When the phrase recognition unit finds a match between an incoming phrase, as defined by a set of parameters, and a phrase stored in its database, also in the same parametric form, the phrase recognition unit can make hypotheses about the identity of each phrase. For example, the phrase recognition unit can determine that a particular phrase is a “steady whistle”, an “up-slur”, a “down-slur”, a “trill”, a “rattle”, a “chirp”, or a “buzz”. The phrases stored in the database of the phrase recognition unit may be subdivided very finely, and may be internally assigned numerical codes for purposes of classification and identification.

The phrases received in the field are usually at least several tenths of a second in length, and often may be much longer. The phrase recognition unit may also measure the amplitude of the phrase to help separate overlapping bird songs.

The output of the phrase recognition unit is therefore a set of patterns of phrases based on what has been detected by the microphone. For example, if the phrase recognition processes the signal represented in FIG. 3, the output of the phrase recognition unit will be an “up-slur” followed by three short chirps. The output of the phrase recognition unit in response to a signal as shown in FIG. 4 would be an up-slur followed by seven short chirps. The up-slur and the chirps could be more finely categorized, and stored as such in the database of the phrase recognition unit. The above description is just a simplified example.

In short, for a given bird call, or other animal call, the phrase recognition unit will, in general, produce a pattern of phrases that characterizes that call.

Song/Call Recognition unit 43 receives the output of the phrase recognition unit and uses that information to make an actual identification of the bird making the particular call. Stored in unit 43 is a database of bird calls, each call being stored as a pattern of phrases. The recognition unit 43 searches the stored patterns in its database, and compares those stored patterns with the patterns of phrases received from phrase recognition unit 42. For example, the database could associate the pattern of phrases represented by FIG. 4 as a “cardinal”, and the recognition unit 43 would therefore generate the output “cardinal” if an incoming pattern of phrases matches what is shown in FIG. 4.

In general, when the song/call recognition unit 43 finds a pattern in its database that closely corresponds with an incoming pattern of phrases, it can declare a “match”, and can generate an identification, either on a display screen, or through an audio output device, or both.

In practice, not every observed call will generate a perfect match with a pattern stored in the database. The song/call recognition unit can be programmed to quantify the degree to which a match is obtained, and thus to assign a confidence level to a particular identification. In some cases, it may even happen that the song/call recognition unit will make two or more hypotheses about the identity of an animal call, leaving it to the human operator to analyze the results further.

In summary, bird calls, or other animal calls, are recognized by the present invention, not by comparing entire waveforms with stored waveforms, but instead by comparing finite sets of parameters defining phrases with similar parameters stored in a database. The present invention reduces each phrase to a set of parameters, and compares each such set of parameters with stored sets of parameters, so as to identify each phrase. Then, the present invention compares groups (or patterns) of phrases, based on recorded sounds, with stored groups of phrases, each stored group of phrases representing a known bird call or other animal call, so as to identify the bird or other animal making the sound. The present invention therefore entirely avoids the need for point-by-point comparison of waveforms.

Any or all of the spectral analysis unit 41, the phrase recognition unit 42, and the song/call recognition unit 43 may be implemented with programmed computers, such as programmed microprocessors. It is also possible that the functions of all of the above components can be performed by the same computer. All of these alternatives are within the scope of the present invention.

The digital audio storage unit 8 allows the user to store a number of actual bird songs for later reference. It may happen that a particular bird call does not match any of the data stored in the song/call recognition unit. The system may so advise the user, and may even be programmed to notify the user that the call being received is that of a very rare bird. The user may therefore choose to record the call or song for later analysis. Alternatively, the user may not agree with the conclusion made by the song recognition unit, and may want to record the song for later manual numerical analysis. To permit the user to make delayed recording decisions, it is necessary to store the input signal continuously for at least about 10 seconds. Since a 10-second segment of audio would require only about 100 kilobits of memory, a large number of such song segments may be easily stored in a hand-held unit.

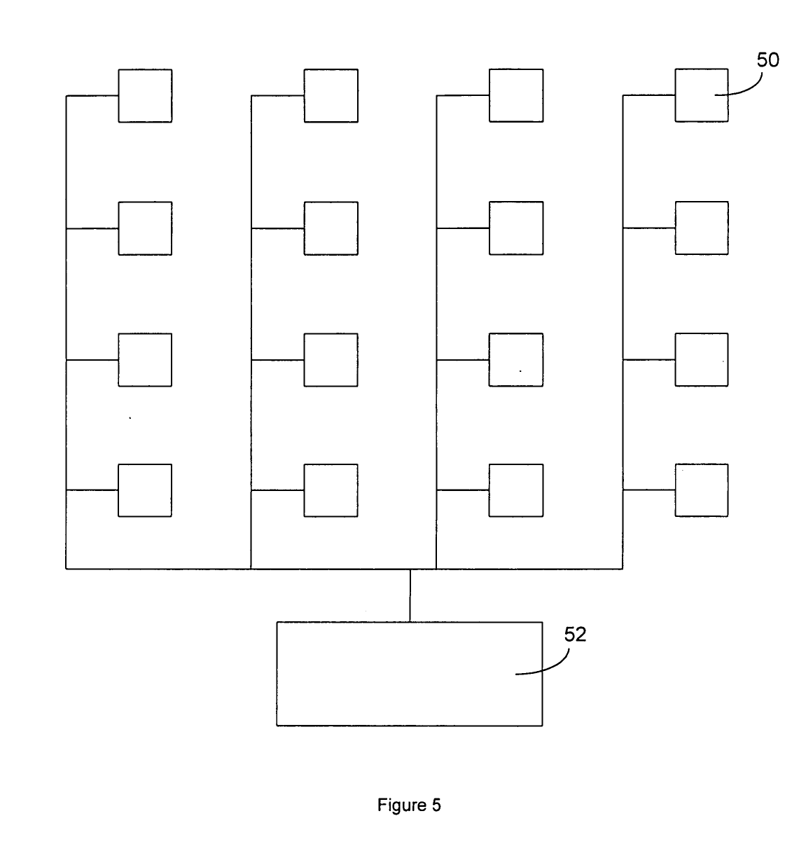

FIG. 5 illustrates another embodiment of the present invention, used to track migratory patterns of birds or other animals. In this embodiment, there are a plurality of devices, all of the general type described above. The devices are distributed over an area, which may extend over many square miles. In the example shown in FIG. 5, there are 16 such devices 50, arranged in a square. The invention is not limited by the choice of the number of such devices, or by the size of the area over which they are distributed. The devices 50 are connected to a central computer 52. The connections are shown explicitly in FIG. 5, but it should be understood that such connections can be either wireless or wire connections.

Each unit 50 automatically identifies the bird calls, or other animal calls, detected by the unit, using the same procedures described above. But instead of reporting the results to a user such as a bird watcher, the results are transmitted automatically to the central computer. Since each unit contains a clock which, among other things, can determine the exact time each song or call was received, the central computer will receive information about what birds (or other animals) were observed at what locations, and when. If the area covered by the devices 50 is large enough, and if the density of such devices is large enough, the information received by the central computer will be sufficient to infer useful information about the migratory patterns of various birds or other animals. The central computer can be programmed to generate charts showing the locations of birds, or other animals, at particular times, and/or charts showing the movement of animals over an extended period of time.

The devices 50 used in the embodiment of FIG. 5 may be modified to suit the application described above. In particular, each device should contain a battery having a capacity which is much greater than that used in the hand-held unit, because these devices would be left in the field for an extended period of time, such as a week or more. Also, because the devices are intended to gather data for an extended period of time, the memory requirements of each device are increased.

The procedures outlined above are preferably implemented using a personal computer architecture, so that the data could be stored on a conventional hard disk having a large storage capacity. The recognition logic could thus be implemented in software, which could be relatively easily developed and upgraded. Such units could be easily implemented for use in different regions of the country or the world, where the bird population changes radically from one region to another.

Another modification of the invention comprises the use of multiple microphones, each focused on a different range of azimuth. For example, six microphones could be used, each devoted solely to a 60-degree angle from the recognition device. In this way, birds singing simultaneously could be recognized, even though their songs would otherwise overlap. The use of multiple microphones could be implemented with either the hand-held device, or the embodiment wherein the devices are left in the field, but this modification is more conveniently used with the latter embodiment, because the devices, once positioned, are not moved.

In the embodiment of FIG. 5, the selection of bird calls to be fully recorded must be automated. There are a variety of criteria which could be used, based on bird song recognition. For example, if there is a high level of uncertainty in the recognition process, the song may be recorded, for later review by a scientist. Or, the song may be recorded if a rare bird is recognized.

The embodiment of FIG. 5 can be used especially by governmental and naturalist organizations, to gather information efficiently regarding the population and migration of bird species.

The invention can be further modified in ways that will be apparent to those skilled in the art. The invention is not limited to use in identifying bird calls, but can be used to identify and/or track other animals, such as whales or porpoises. The apparatus need not be a handheld unit, but instead could be provided as a stationary device, using essentially the same circuitry and programming as described above. The invention is not limited by the particular parameters chosen to represent phrases. Parameters other than those given by way of example, above, could be used, within the scope of the invention. The use of more parameters will increase the likelihood of an accurate identification, but will require more computation time. These and other modifications should be considered within the spirit and scope of the following claims.

What is claimed is:

1. A method of automatically identifying animal sounds, comprising:
a) recording a sound produced by an animal,
b) analyzing said sound to determine at least one phrase included in said sound,
c) comparing phrases determined in step (b) with stored phrase patterns associated with various animals, and
d) identifying an animal according to a result of step (c).

2. The method of claim 1, wherein step (b) comprises measuring a set of parameters associated with a phrase forming part of the sound recorded in step (a), and comparing said set of parameters with a stored set of parameters, so as to determine an identity of said phrase.

3. The method of claim 1, wherein said parameters comprise one or more members of the group consisting of starting time, ending time, lowest frequency, highest frequency, average frequency, median frequency, and dominant frequency.

4. The method of claim 1, wherein step (b) includes passing said sound through a comb filter, so as to analyze sounds within a plurality of frequency bands.

5. A method of automatically identifying an animal sound, comprising:
a) recording a sound made by the animal,
b) identifying at least one phrase in said sound,
c) defining said at least one phrase by a plurality of parameters, and
d) comparing patterns of phrases obtained in step (c) with stored data containing patterns of phrases relating to sounds of known animals.

6. A method of automatically tracking migratory patterns of animals, comprising:
a) placing a plurality of identification units in a plurality of locations, each identification unit comprising means for recording a sound produced by an animal and for comparing attributes of said sound with stored information so as to identify an animal producing said sound, the identification units being connected to a central computer, and
b) analyzing paths taken by particular animals as determined by information received from each of the identification units.

7. The method of claim 6, wherein each identification unit is selected to include:
a) means for recording a sound produced by an animal,
b) means for analyzing said sound to determine at least one component phrase included in said sound,
c) means for comparing phrases determined by the analyzing means with stored phrase patterns associated with various animals, and
d) means for identifying an animal according to an output of the comparing means.

8. The method of claim 7, wherein the analyzing means is selected to include means for measuring a set of parameters associated with a phrase forming part of the sound recorded by the recording means, and means for comparing said set of parameters with a stored set of parameters, so as to determine an identity of said phrase.

9. A method of automatically tracking migratory patterns of animals, the method comprising:
a) placing a plurality of identification units in a plurality of locations, each identification unit comprising means for recording a sound produced by an animal and for automatically identifying an animal producing said sound, the identification units being connected to a central computer,
b) transmitting data from said identification units to said central computer, and
c) analyzing paths of animals as determined by said data received from each of the identification units.

10. Apparatus for automatically tracking migratory patterns of animals, comprising:
a) a plurality of identification units disposed in a plurality of locations, each identification unit comprising means for recording a sound produced by an animal and for automatically identifying an animal producing said sound, the identification units being capable of transmitting data to a central computer,
b) wherein the central computer is programmed to analyze migratory paths taken by animals, based on data transmitted to the central computer from said identification units.

11. Apparatus for automatically identifying animal sounds, comprising:
a) a microphone for receiving sounds,
b) a computer programmed to detect at least one phrase in said sounds, and to characterize said phrase in terms of a plurality of parameters,
c) the computer also including a memory containing stored parameters representing known phrases, the computer being programmed to compare phrases detected in said sounds with phrases stored in said memory, wherein the computer is programmed to detect patterns of phrases in said sounds,
d) the computer also including a database containing patterns of phrases of known animals, the computer being programmed to compare patterns of phrases in sounds received by the microphone with patterns stored in the database, so as to identify an animal making said sounds.

12. Apparatus for automatically identifying animal sounds, comprising:
a) means for receiving sounds from an environment,
b) means for analyzing said sounds so as to identify phrases in said sounds, wherein the analyzing means comprises means for determining parameters associated with each phrase,
c) means for comparing said parameters with stored parameters associated with known phrases, wherein the comparing means comprises means for identifying phrases,
d) means for comparing patterns of phrases with stored patterns of phrases associated with known animals, wherein the pattern comparing means comprises means for identifying an animal making said sounds.

13. Apparatus for automatically identifying animal sounds, comprising:
a) a microphone for receiving incoming sounds,
b) a comb filter, the comb filter being connected to the microphone, and being capable of measuring signals appearing in narrow frequency bands,
c) a spectral analysis unit, connected to the comb filter, and capable of dividing incoming signals into phrases and of characterizing said phrases by a finite set of parameters,
d) a phrase recognition unit, connected to the spectral analysis unit, the phrase recognition unit including stored information about various phrases, the phrase recognition unit being capable of comparing phrases defined by the spectral analysis unit with phrases stored in the phrase recognition unit so as to identify such phrases, and
e) a song/call recognition unit, connected to the phrase recognition unit, the song/call recognition unit including a database of animal sounds stored as patterns of phrases, the song/call recognition unit being capable of comparing patterns of phrases received from the phrase recognition unit with patters of phrases stored in the song/call recognition unit, so as to identify an animal making said incoming sounds.

14. The apparatus of claim 13, further comprising an electronic clock, disposed in at least one of the spectral analysis unit, the phrase recognition unit, and the song/call recognition unit, for identifying a time at which a particular sound was received.

15. The apparatus of claim 14, further comprising means for storing incoming sounds and for playback of said sounds.

16. The apparatus of claim 13, further comprising a display, connected to the song/call recognition unit, for advising a user of an identity of an animal making said incoming sounds.
